(19) United States
(12) Patent Application Publication
(10) Pub. No.: US 2003/0083855 A1
(43) Pub. Date: May 1, 2003

(54) Method for generating logic simulation model

(76) Inventor: Hiroyuki Fukuyama, Yamanashi (JP)

Correspondence Address: WENDEROTH, LIND & PONACK, L.L.P., 2033 K STREET N. W., SUITE 800, WASHINGTON, DC, 20006-1021, US

(21) Appl. No.: 10/131,249

(22) Filed: Apr. 25, 2002

(30) Foreign Application Priority Data
Oct. 30, 2001 (JP) 2001-333405

(51) Int. Cl. G06F 17/50

(52) U.S. Cl. 703/15

(57) ABSTRACT

For each predetermined operational unit of a semiconductor device for which a logic simulation model is to be generated, several types of operational descriptions (MRS operating sections, bank selecting operating sections, and the like) having different functions are stored in advance as a group of operational description libraries in a hard disk. Then, specifying information which specifies operational descriptions that will be applied to the logic simulation model are inputted. The specified operational descriptions are then read out of the hard disk. Then a model body section which is the core of the logic simulation model is generated based on the read operational description. Thus, a method, an apparatus and a program for generating a logic simulation model, and a recording medium for recording the program, which can greatly reduce the procedures required for generating and maintaining the logic simulation model, are provided.

### BACKGROUND OF THE INVENTION

1. Field of the Invention

The present invention relates to a method, an apparatus and a program for generating a logic simulation model, and a recording medium for recording the program. More particularly, the present invention relates to a method, an apparatus and a program for generating a logic simulation model of semiconductor devices such as a semiconductor integrated circuit, and a recording medium for recording the program.

2. Description of the Related Art

A logic simulation has been a simple method for verifying operations of various systems, circuits and the like, for example: a system, which has a semiconductor memory such as a dynamic random access memory (DRAM), a synchronous DRAM (SDRAM), a read-only memory (ROM), a flash memory or the like; a semiconductor integrated circuit, to which the semiconductor memory is connectable; and the semiconductor memory itself. The logic simulation is executed by using a logic simulation model of the semiconductor memory. The logic simulation model is often referred to as a logic simulation functional model.

FIG. 12 schematically illustrates the following three example applications of the logic simulation model, where an SDRAM is used as the semiconductor memory.

1. An application in which an SDRAM user reproduces the SDRAM operations to verify, through the logic simulation, operations of a board having the SDRAM mounted thereon.

2. An application in which a designer of a large scale integrated circuit (LSI), to which the SDRAM is connectable, reproduces the SDRAM operations to verify operations of the LSI through the logic simulation.

3. An application in which an SDRAM designer confirms whether actual operations of the SDRAM conform to the specifications thereof. Here, the logic simulation model of the SDRAM is being used as a device that can simulate the specifications of the SDRAM.

To generate a logic simulation model of the semiconductor memory, a template is generally prepared for each type of the semiconductor memory. In the template, data indicating physical sizes, such as an address signal width or a data signal width, and data indicating timings such as an access time, are set as parameters. Examples of the parameters include: “10 bits” when the address signals are A0, A1, . . . , A9; and “8 bits” when the data signals are D0, D1, . . . , D9. The parameters indicating the physical size and the timing will hereinafter be referred to as, physical parameters and, timing parameters, respectively.

Thus, by setting data to the physical size parameters or the timing parameters of the template of the semiconductor memory whose operations are exactly the same as those of the semiconductor memory for which the logic simulation model is to be generated, a logic simulation model is generated in accordance with desired physical structures and timings.

By setting physical sizes, such as a data signal width, and timings, such as access time, as parameters, the above method for generating a logic simulation model can be applied to various derivative products having different parameters. However, for any semiconductor memory whose operations, even merely a part thereof, differ from those of the above semiconductor memory, the template must be rebuilt. Rebuilding and maintenance of the templates require additional labor.

Logic simulation models of semiconductor memories require a much larger quantity of description as compared with logic simulation models of semiconductor basic cells such as inverter cells or flip-flop cells. For example, it requires only several tens of lines to describe the inverter cells or the flip-flops using the Verilog-Hardware Description Language (Verilog-HDL), a kind of hardware description language, whereas it often requires nearly 3,000 lines to describe the SDRAM, which is a kind of semiconductor memory.

Accordingly, both rebuilding templates due to partial differences in operation and maintenance of the template require many additional procedures.

### SUMMARY OF THE INVENTION

To overcome the disadvantages of the prior art, it is an object of the present invention to provide a method, an apparatus and a program for generating a logic simulation model, and a recording medium for recording the program, that greatly reduce the required procedures for generating and maintaining the logic simulation model.

In order to achieve the above object, a first aspect of the present invention is a method for generating a logic simulation model of a semiconductor device, which comprises the steps of: storing in advance, in a storing section, several types of operational descriptions having different functions for each predetermined operational unit of a semiconductor device for which the logic simulation model is to be generated; inputting specifying information, which specifies the operational descriptions, among the several types of operational descriptions, to be applied to the logic simulation model to the storing section; reading out the operational descriptions specified by the specifying information from the storing section; and generating the logic simulation model based on the read operational descriptions.

According to the first aspect of the present invention, regarding the semiconductor device for which the logic simulation model is to be generated, several types of operational descriptions having different functions are stored in advance in the memory for each predetermined operational unit. The operational descriptions are constructed by descriptions of contents of the operations written in a hardware description language such as Verilog-HDL or VHDL (Very High Speed IC Hardware Description Language). Examples of the memories include: storage elements such as a ROM, an electrically erasable and programmable ROM (EEPROM), and a flash memory; portable recording media such as a floppy disk, a compact disc-recordable (CD-R), a compact disc-rewritable (CD-RW), a magneto-optical disc, and a magnetic tape; fixed recording media such as a hard disk; and external memories provided at a server computer, or the like, and connected to a network.

In the first aspect of the present invention, the logic simulation model is generated in the following manner: specifying information which specifies an operational description that will be applied to the logic simulation model, from among the several types of operational descriptions, is inputted; the operational description specified by the specifying information is read out of the storing means; then a logic simulation model is generated based on the read operational description.

In the first aspect of the present invention, the logic simulation model is generated by storing in advance, in the storing means, several types of operational descriptions with different functions for each predetermined operational unit of the semiconductor device for which a logic simulation model is to be generated, and selectively using one of the several types of operational descriptions which corresponds to desired functions. Thus, even if a logic simulation model which has slightly different operations is to be generated, an operational description can be selected which corresponds to the different operations. It is thus unnecessary to rebuild a template, thereby reducing the procedures. Further, even if an accident occurs in a part of the logic simulation model or an additional function needs to be added to a logic simulation model, it suffices to revise or add that operational description. As a result, the number of procedures required to maintain the logic simulation model can be greatly reduced.

According to the method for generating a logic simulation model of the first aspect of the present invention, the number of procedures required to generate and maintain the logic simulation model can be decreased.

A second aspect of the present invention is the method of the first aspect, which further comprises the steps of: storing in advance, in the storing section, physical information and timing information for operational timing, which are common for each type of semiconductor device, and sequential information indicating operational sequence as common information for the semiconductor device for which the logic simulation model is to be generated; inputting, into the storing section, specific numeric information defining the physical information and the timing information for the semiconductor device; reading out the operational descriptions specified by the specifying information, and the common information corresponding to the type of the semiconductor device from the storing section; and generating the logic simulation model based on the read operational descriptions and the common information that are read out and the numeric information.

The physical information includes information which identifies bit widths of various signals that are inputted or outputted at the semiconductor device.

In the second aspect of the present invention, a logic simulation model in accordance with desired physical conditions or operational timing conditions can be generated by inputting desired physical information or timing information as the numeric information. As a result, the present invention can be applied to derivative products having different physical conditions or operational timing conditions.

According to the second aspect of the present invention, the method for generating the logic simulation model can be applied to derivative products having different physical conditions or operational timing conditions while achieving the same effects as those of the method of the first aspect of the present invention.

A third aspect of the present invention is the method of the first aspect, wherein the semiconductor device is a semiconductor memory.

According to the method of the third aspect of the present invention, since a semiconductor memory is used as the semiconductor device, a logic simulation model in accordance with desired physical conditions or operational timing conditions can be generated or maintained with fewer procedures, while achieving the same effects as those of the method of the first or the second aspect of the present invention.

In a fourth aspect of the present invention, the operational unit in the first through the third aspects of the present invention can be a command unit.

Accordingly, regarding a semiconductor device, such as the SDRAM, the DRAM and the flash memory, in which one operation among several types of operations may be selected for each command, a logic simulation model can be generated by selectively applying any one of several types of operational descriptions having different functions to each command of the semiconductor device. Thus, the structure of the logic simulation model can be simplified.

To achieve the above object, a fifth aspect of the present invention is an apparatus for generating a logic simulation model of a semiconductor device, which comprises: a storing section storing in advance several types of operational descriptions having different functions for each predetermined operational unit of a semiconductor device for which the logic simulation model is to be generated; an inputting section for inputting specifying information that specifies the operational descriptions, from among the several types of operational descriptions, to be applied to the logic simulation model; and a generating section which reads out the operational description specified by the specifying information from the storing section, and generates the logic simulation model based on the read operational descriptions.

According to the apparatus for generating a logic simulation model of the fifth aspect of the present invention, several types of operational descriptions having different functions are stored in advance in the memory for each predetermined operational unit of the semiconductor device for which the logic simulation model is to be generated. The operational descriptions are contents of the operations written in the hardware description languages such as the Verilog-HDL and the VHDL. Examples of the memories include: storage elements such as the ROM, the EEPROM, and the flash memory; portable recording media such as the floppy disk, the CD-R, the CD-RW, the magneto-optical disc, and the magnetic tape; fixed recording media such as the hard disk; and external memories provided at a server computer, or the like, and connected to the network.

In the fifth aspect of the present invention, the logic simulation model is generated in the following manner: among the several types of operational descriptions, the specifying information which specifies the operational description that will be applied to the logic simulation model is inputted by the inputting means; the operational description identified by the specifying information is read out by the generating means from the storing means; then a logic simulation model is generated in accordance with the read operational description.

Since the apparatus of the fifth aspect of the present invention has the same effects as those of the first aspect of the present invention, the logic simulation model can be generated and maintained with a lot fewer procedures.

A sixth aspect of the present invention is a program for generating a logic simulation model. When implemented on a computer, the program achieves the same effects as those of the first aspect of the present invention.

A seventh aspect of the present invention is a computer-readable recording medium having a program for generating a logic simulation model recorded thereon. With the program, a computer can execute the same procedures as those of the first aspect of the present invention. Examples of the recording medium include those described in connection with the memories of the fifth aspect.

To achieve the above object, an eighth aspect of the present invention is a method for generating a logic simulation model of a semiconductor device using a storing section, which comprises the steps of: storing a plurality of command operational information specifying each of several types of command operations that are executed by the semiconductor device, and several types of operational descriptions having different functions, which are included in each of the several types of command operations, in the storing section; inputting specifying information into the storing section that specifies the operational descriptions, from among the several types of operational descriptions, to be applied to the logic simulation model; and generating the logic simulation model by reading out, from the storing section, the operational descriptions specified by the specifying information and generating the logic simulation model based on the read operational descriptions read.

In the method of the eighth aspect of the present invention, command operation information indicating each of the several types of command operations, which are executed by the semiconductor device, and several types of operational descriptions having different functions, which are included in each of the various types of command operations, are recorded to the recording means by a recording process. The command operation information is information which can distinguish among the several types of corresponding command operations (distinguish a corresponding command operation among the several types of command operations). The operational descriptions are formed by describing the contents of the operations using a hardware description language such as Verilog-HDL, VHDL, or the like. Examples of the memory include those described in connection with the memory of the fifth aspect.

Furthermore, in the eighth aspect of the present invention, specifying information, which specifies an operational description, from among the several types of operational descriptions, to be applied to the logic simulation to be generated, is inputted by an inputting process. The operational description, which was specified by the specifying information, is read from the memory by a generating process, and a logic simulation is formed based on the operational description, which was read.

In the method of the eighth aspect of the present invention, several types of operational descriptions having different functions, which are included in each of several types of command operations applied in the semiconductor device for which a logic simulation model is to be generated, are stored in advance in a memory. A logic simulation model is generated by selectively using any one of the several types of operational descriptions in accordance with desired functions. Thus, even if a logic simulation model which has slightly different operations is to be generated, an operational description in accordance with the different operations can be selected. It thus becomes unnecessary to rebuild the template, thereby reducing the number of procedures required. Further, even if a problem occurs in part of the logic simulation model or an additional function is to be added to the logic simulation model, it suffices to revise or to add that operational description. As a result, the number of procedures required for maintenance of the logic simulation model can be greatly reduced.

Accordingly, in the method of the eighth aspect of the present invention, the number of procedures required for generating and maintaining the logic simulation model can be decreased.

### BRIEF DESCRIPTION OF THE DRAWINGS

FIG. 1 is a perspective external drawing of an apparatus for generating a logic simulation model relating to an embodiment of the present invention;

FIG. 2 is a block diagram schematically showing a structure of an electric system of an apparatus for generating a logic simulation model relating to an embodiment;

FIG. 3 is a diagram schematically illustrating a structure of a logic simulation model relating to an embodiment;

FIG. 4 is a table showing examples of command operations that have several selectable command operations within command operations prepared in an apparatus for generating a logic simulation model relating to an embodiment;

FIG. 5 is a table showing another example of command operations that have several selectable command operations within command operations prepared in an apparatus for generating a logic simulation model relating to an embodiment;

FIG. 6 is a flow chart showing a process stream of a program for generating a logic simulation model relating to an embodiment;

FIG. 7 is a diagram which explains a procedure for generating a model body section 104 of a logic simulation model relating to an embodiment;

FIG. 8 is a diagram which explains an incorporation of an operational description relating to an embodiment into a common descriptive section 101 and illustrates an exemplary description of an operational sequence;

FIGS. 9A-9C are diagrams each of which explains an incorporation, into the common descriptive section 101, of an operational description relating to an embodiment and illustrates an exemplary description of an operational description;

FIG. 10 is a diagram which explains an incorporation of an operational description relating to an embodiment into the common descriptive section, and illustrates an exemplary description in the model body section 104 obtained by the incorporation;

FIG. 11 is a diagram showing a procedure for a logic simulation in accordance with a logic simulation model which is generated by an apparatus 10 for generating a logic simulation model relating to an embodiment; and

FIG. 12 is a diagram schematically illustrating exemplary applications of a logic simulation model, where an SDRAM is used as a semiconductor memory.

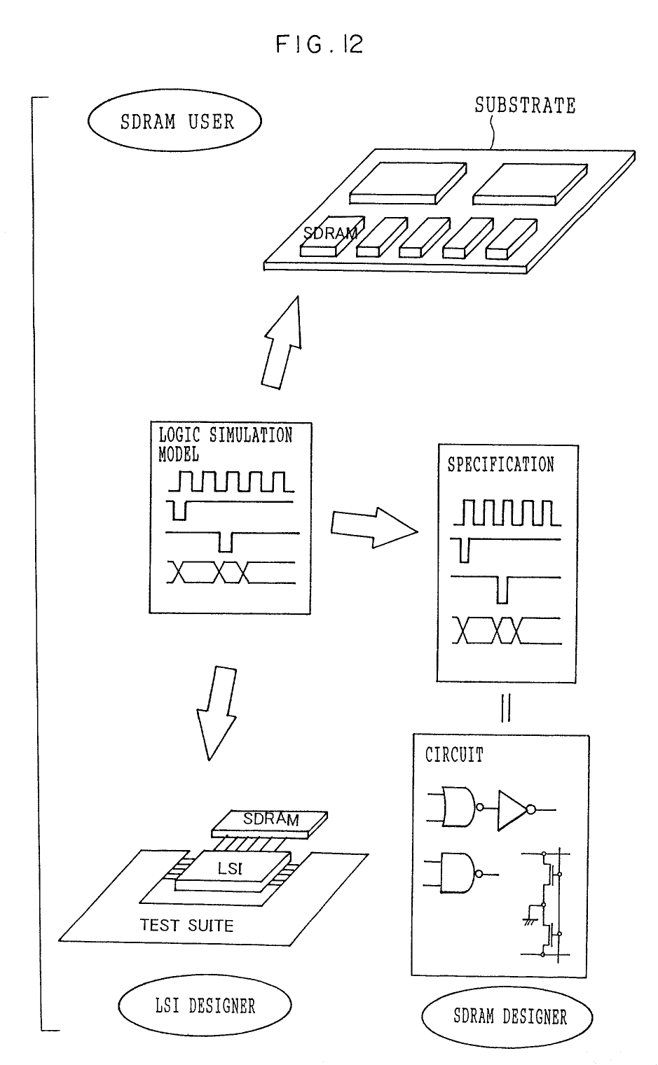

### DETAILED DESCRIPTION OF THE PREFERRED EMBODIMENTS

Embodiments of the present invention will now be described in detail. For illustrative purposes only, the method and the apparatus for generating a logic simulation model of the present invention will be described in conjunction with a general purpose personal computer. Here, a semiconductor memory is used as the semiconductor device of the present invention.

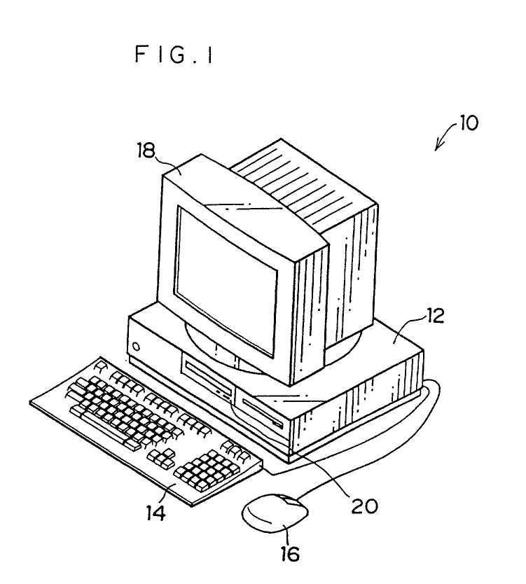

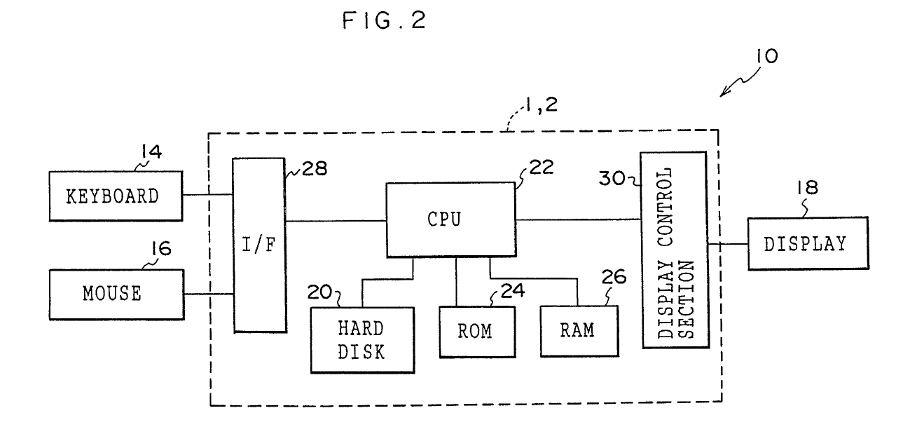

Referring first to FIGS. 1 and 2, a structure of a logic simulation model generating apparatus 10 relating to the present embodiment will be explained. As shown in FIG. 1, the apparatus 10 comprises a control section 12 which controls all operations of the apparatus 10, a keyboard 14 and a mouse 16 with which an operator enters various information, and a display 18 which displays various menus, messages and the like. The control section 12 includes a hard disk 20.

As shown in FIG. 2, the control section 12 includes a central processing unit (CPU) 22. Connected to the CPU 22 are a hard disk 20, a ROM 24 having various programs, data and the like recorded thereon, and a RAM 26, which is used as a working area, or the like, when the CPU 22 executes programs.

The keyboard 14 and the mouse 16 are connected to the CPU 22 via an interface (I/F) 28. The display 18 is also connected to the CPU 22 via a display control section 30.

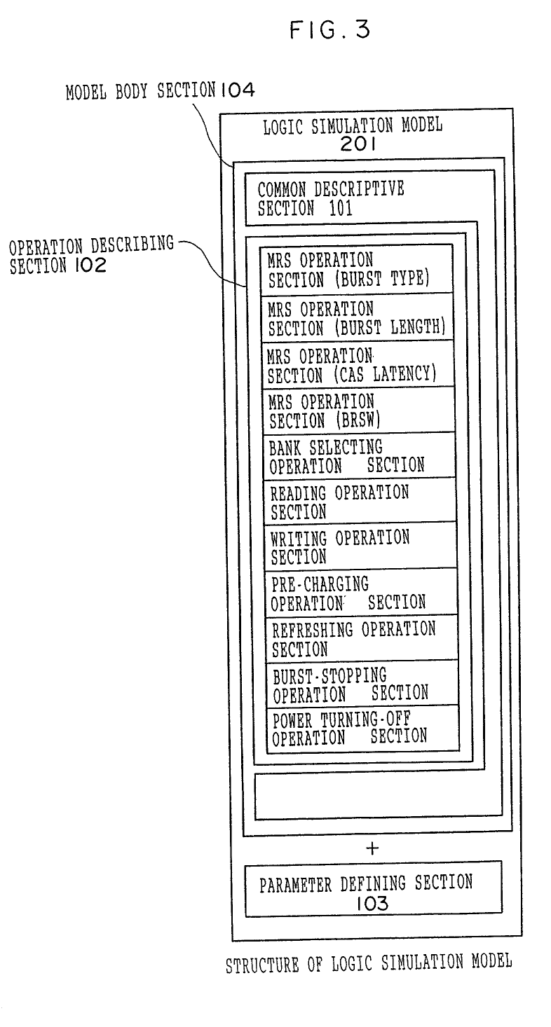

FIG. 3 illustrates a structure of a logic simulation model 201 which is generated by the apparatus 10. As shown, the logic simulation model 201 consists of a model body section 104 and a parameter defining section 103. The model body section 104 consists of a common descriptive section 101 and an operation descriptive section 102. The common descriptive section 101 describes information which is common in each type of semiconductor memory. The common information includes a terminal definition (i.e., physical information), a timing definition (i.e., timing information), an operational sequence for each predetermined operational unit (i.e., a command operation), an error processing procedure, and the like. The operation descriptive section 102 describes contents (i.e., operational descriptions) of the command operations indicated by the operational sequence that is written in the common descriptive section 101.

The common descriptive section 101 describes information which is common in each type of semiconductor memory, even if the semiconductor memories have different operations. The terminal definition written in the common descriptive section 101 defines information such as the name of each terminal (e.g., an address terminal or a data terminal provided at the semiconductor memory), the name of each parameter required for each terminal, and the like. The timing definition defines information, such as the name of each operational timing parameter, which is required when the semiconductor memory operates.

The parameter defining section 103 describes numeric data (i.e., numeric information) of parameters that are defined as the terminal definition or the timing definition in the common descriptive section 101.

For example, when address terminals A0, A1, . . . , A9 are to be defined, the common descriptive section 101 defines “A” and “bit width” as the terminal definition, and the parameter defining section 103 defines numeric data (“10” in this case) as a physical size parameter that indicates the bit width. When timing TA0, TA1, . . . , TA9 for each of the address terminals A0, A1, . . . , A9 are to be defined, the common descriptive section 101 defines “TA0,” “TA1,” . . . , “TA9,” and the parameter defining section 103 defines numeric data such as “10 ns,” “8 ns” as timing parameters.

The physical size parameters and the timing parameters defined in the parameter defining section 103 can be used in the common descriptive section 101 and the operation descriptive section 103.

The operational descriptions to be written in the operation descriptive section 102 are stored in advance in the hard disk 20 as libraries for each command operation and can be plugged into or taken out of the logic simulation model for each command operation. That is, each command unit incorporates one of each of the operational descriptions, which are determined by the semiconductor device for which the logic simulation model is to be generated.

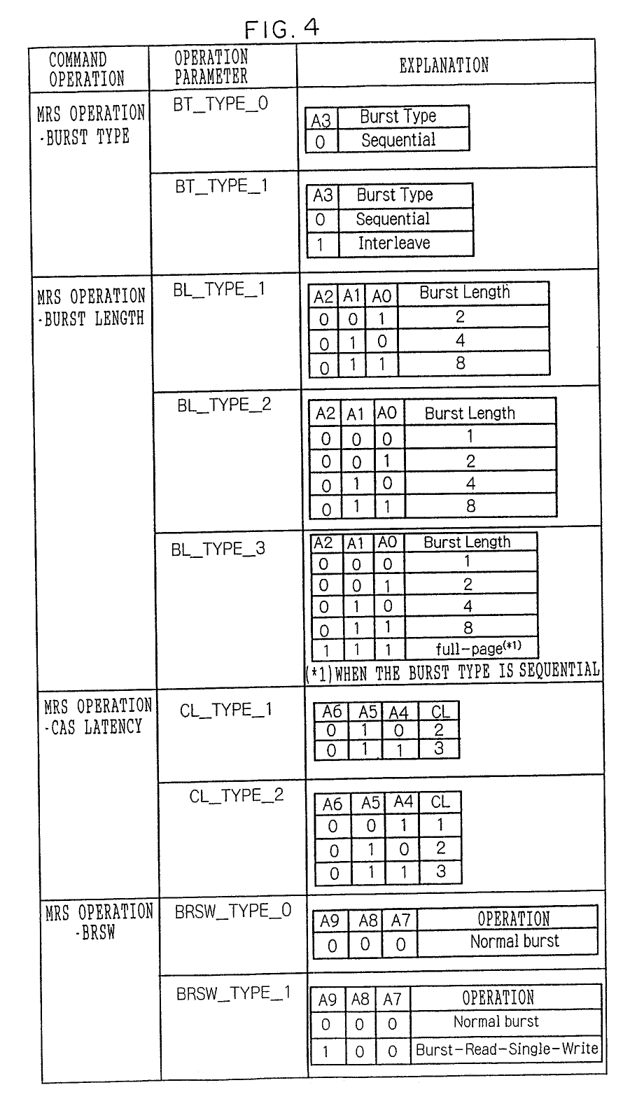

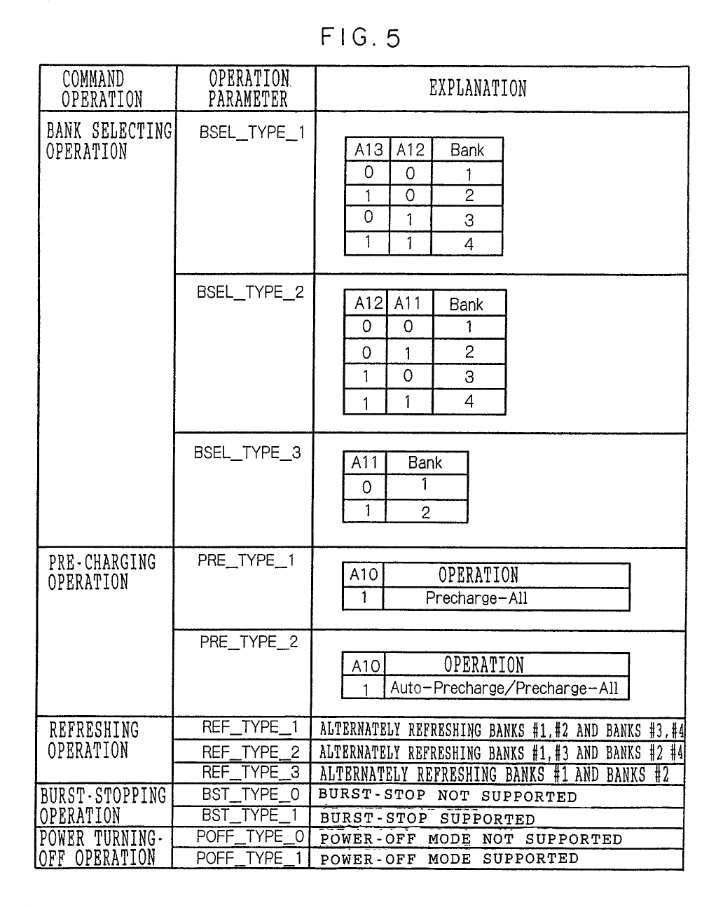

Referring to FIGS. 4 and 5, examples of the command operation prepared in the logic simulation model generating apparatus 10 relating to the present embodiment will be described. In particular, the command operations of the SDRAMs, wherein an operation is often chosen from among several alternatives for a given command will be explained.

An “MRS (mode register set) operation” in FIG. 4 is a command operation for setting the operation mode of the SDRAM. The MRS operation comprises setting a burst type, a burst length, a CAS latency, and a burst-read-single-write (BRSW) of the SDRAM.

The MRS operation for determining the burst type prepares two kinds of operational descriptions: an operational description which only supports sequential operations; and an operational description which supports both the sequential operations and interleave operations.

Both of these operational descriptions are referred to by a task name, “mrs_bursttype( ).” Each operational description, however, can be identified by its own operational parameter assigned in advance to each of the operational descriptions. The operational parameter of the operational description which only supports the sequential operations is, “BT_TYPE_{—}0.” The operational parameter of the operational description which supports both the sequential and the interleave operations is, “BT_TYPE_{—}1.” The operational parameter herein will refer to an identification name which identifies several operational descriptions that belong to the same command operation while having slightly different functions.

For example, in a case in which an operational description, which supports both the sequential operations and the interleave operations and has the operational parameter, “BT_TYPE_{—}1,” is plugged into a logic simulation model, when the sequential type of the logic simulation model for logic simulation is to be determined, the address A3 (i.e., the fourth bit from the least significant bit (LSB)) is set to 0. When the interleave type of the logic simulation model is to be determined, the address A3 is set to 1.

Three types of operational descriptions are available as the MRS operation for setting the burst length, namely: an operational description which supports three burst lengths of 2, 4 and 8; an operational description which supports four burst lengths of 1, 2, 4 and 8; and an operational description which supports five burst lengths of 1, 2, 4, 8 and “full-page.”

All of these operational descriptions are referred to by a task name, “mrs_burstlength( ).“Each operational description, however, can be identified by its own operational parameter assigned in advance to each of the operational descriptions. The operational parameters of the operational descriptions which support three, four, and five burst lengths are “BL_TYPE_{—}1,” “BL_TYPE_{—}2,” and “BL_TYPE_{—}3,” respectively.

For example, in a case in which an operational description, which also supports the burst length of 1 and has the operational parameter “BL_TYPE_{—}2” or “BL_TYPE_{—}3,” is plugged into a logic simulation model, when the burst length of 1 is to be set for executing the logic simulation using the logic simulation model, all of the addresses A2, A1 and A0 are set to 0. When the burst length of 2 is to be set, the addresses A2, A1 and A0 are set to 0, 0, and 1, respectively.

Similarly, regarding the MRS operation for setting the CAS latency, two types of operational descriptions are prepared to, each of which is assigned an operational parameter of “CL_TYPE_{—}1” or “CL _TYPE_{—}2.” Regarding the MRS operation for setting the BRSW, two types of operational descriptions are prepared, to each of which is assigned an operational parameter of “BRSW_TYPE_{—}0” or “BRSW_TYPE_{—}1.”

Further, in the logic simulation model generating apparatus 10 relating to the present embodiment, as shown in FIG. 5, the following command operations are prepared: a bank selecting operation for selecting banks; a pre-charging operation for setting a pre-charge operation; a refreshing operation for setting a refreshing operation; a burst-stopping operation for setting a burst-stop which stops the burst operation; and a power turning-off operation for pseudo turning-off of a power supply in order to reduce electric power consumption.

Regarding the bank selecting operation, three types of operational descriptions are available to be assigned as an operational parameter “BSEL_TYPE_{—}1,” “BSEL_TYPE_{—}2” or “BSEL_TYPE_{—}3.” Regarding the pre-charging operation, two types of operational descriptions are available to be assigned as an operational parameter “PRE_TYPE_{—}1” or “PRE_TYPE_{—}2.” Three types of operational descriptions are available as the refreshing operation to be assigned as an operational parameter “REF_TYPE_{—}1,” “REF_TYPE_{—}2” or “REF_TYPE_{—}3.” Two types of operational descriptions are available as the burst stopping operation to be assigned as an operational parameter “BST_TYPE_{—}0” or “BST_TYPE_{—}1.” Two types of operational descriptions are available as the power turning-off operation to be assigned as an operational parameter “POFF_TYPE_{—}0” or “POFF_TYPE_{—}1.”

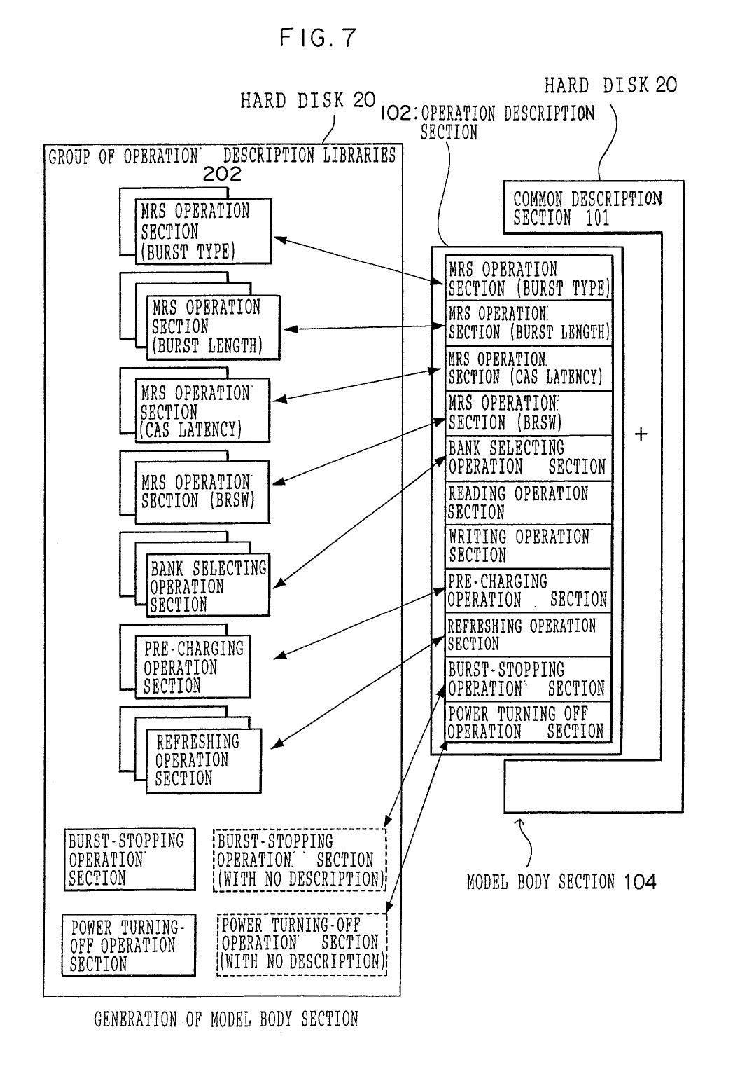

In the hard disk 20 of the logic simulation model generating apparatus 10, many operational descriptions whose contents and operations have been sufficiently verified (i.e., confirmed) are stored in advance as a group of libraries 202 (see FIG. 7).

In the logic simulation model generating apparatus 10, the group of operational description libraries 202 is stored in the hard disk 20 by being transferred from another device via unillustrated communication lines. By storing the group of libraries 202 on a floppy disk, however, the group of libraries 202 can also be inputted into the hard disk 20 of the apparatus 10 by a floppy disk drive provided on the apparatus 10.

In addition to the group of operational description libraries 202, descriptions which correspond to the common descriptive section 101 are also stored in advance in the hard disk 20. The operator of the logic simulation generating device 10 enters various information, such as terminal definitions, timing definitions and operational sequences which is described in the common descriptive section 101, into the hard disk 20 in advance via the key board 14 and the mouse 16. The operational sequence written in the common descriptive section 101 is formed by continuously describing task names of the operational descriptions to be executed. Further, in the hard disk 20, the common descriptive section 101, whose contents have sufficiently been verified for each variety of semiconductor memory that can be applied to the apparatus 10, is stored.

The operator of the apparatus 10 prepares text files which have descriptions of: physical size parameters (a physical size file) and timing parameters (a timing file) of the semiconductor memory for which a logic simulation model is to be generated; and operational parameters indicating operational descriptions to be incorporated in the logic simulation model to be generated (specifying information or operation parameter files). These text files are stored in the hard disk 20 (i.e., in the storing portion) of the apparatus 10.

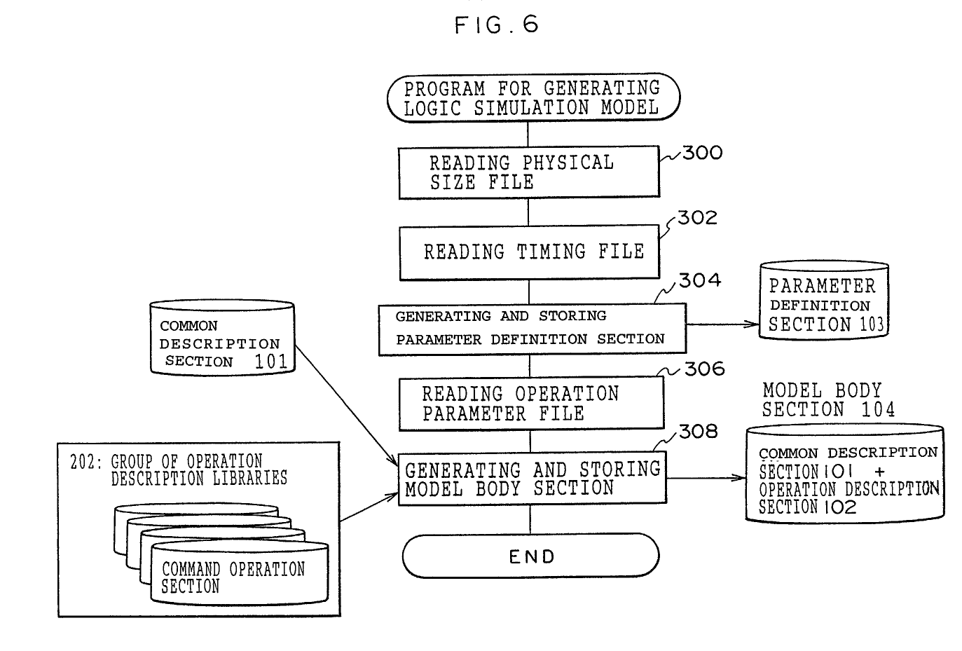

Next, referring to FIG. 6, the operation of the logic simulation model generating apparatus 10 relating to the present embodiment will be described. FIG. 6 is a flow chart showing a logic simulation generating program, which is executed in the CPU 22 when the logic simulation model is generated in the logic simulation model generating apparatus 10. The program is stored in advance in the ROM 24 (i.e., in the recording medium). The program will be explained in conjunction with a logic simulation model of the SDRAM, which is a kind of semiconductor device.

In Step 300 in FIG. 6, various numeric data is entered by reading out the physical files from the hard disk 20. The numeric data indicates the address signal size, the row address signal size, the column address signal size, the data signal size, the data signal mask (DQM) and the bank size.

In Step 302, various numeric data is inputted by reading out the timing files from the hard disk 20. The numeric data indicates the clock cycle, the access time, the clock pulse time, the input setup time, the input hold time, the output low-impedance time, the output high-impedance time, the output hold time, the RAS cycle time, the RAS pre-charge time, the RAS, CAS delay time, the light recovery time, the bank active delay time, the refresh cycle, the CAS, CAS delay time, the CKE clock disable time, the DQM output high-impedance time, the DQM data mask time, the pre-charge output high impedance time, the MRS-active command input time and the data output-write command input time.

In Step 304, a parameter defining section 103 (see FIG. 3) is generated by a generating means in accordance with the inputted physical size parameters and the timing parameters, and stored in the hard disk 20.

In Step 306, operational parameter which indicates the operational description of the command operation to be applied is inputted by reading out the operational parameter file from the hard disk 20. In Step 308, the model body section 104 is generated and is stored in the hard disk 20 (the generating step).

The model body section 104 is generated by the following procedure. The operational sequence, which is written in the common descriptive section 101 that has been stored in advance in the hard disk 20, is read out (the reading-out step).

Then, as shown in FIG. 7, operational descriptions that are specified by the operational parameters inputted in Step 306 are read out of the group of operational description libraries 202 for all the command operations included in the read operational sequence, and the operation descriptive section 102 is generated.

Finally, the thus generated operation descriptive section 102 is incorporated into the common descriptive section 101, which corresponds to the SDRAM for which the logic simulation model is to be generated. As a result, the model body section 104 whose contents and operations are fully verified is generated.

After the model body section 104 is generated, the program for generating the logic simulation model is completed.

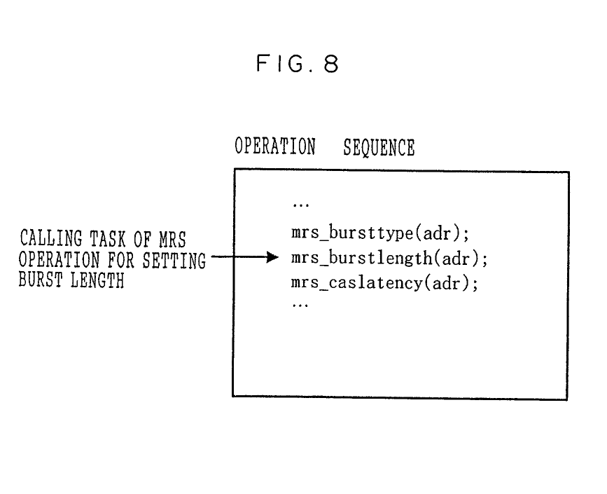

Next, referring to FIGS. 8, 9A-9C and 10, the incorporation of the operational descriptions into the common descriptive section 101 in Step 308 of the program will be explained in conjunction with the MRS operation for setting the burst length. For illustrative purposes, the logic simulation model is written in the Verilog-HDL here.

As shown in FIG. 8, the sequence for calling the task “mrs_burstlength( )” of the operational description of the MRS operation for setting the burst length is written in the common descriptive section 101.

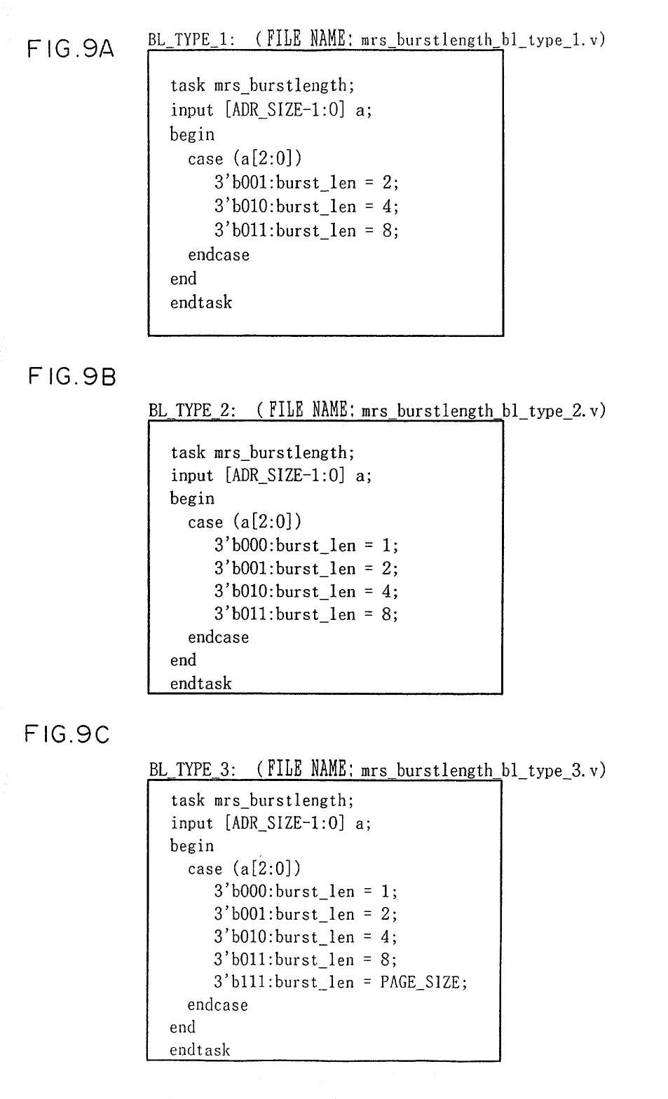

As shown in FIGS. 9A-9C, any of the aforementioned three types of operational descriptions (i.e., the operational descriptions whose operational parameters are “BL_TYPE_{—}1,” “BL_TYPE_{—}2” and “BL_TYPE_{—}3”) can be incorporated into the common descriptive section 101 as the operational description for the MRS operation for setting the burst length. Although all of these operational descriptions are referred to by the same task name, “mrs_bursttype( ),” each operational description is managed under separate file name. Note that FIGS. 9A-9C only illustrate descriptions regarding main operations, and descriptions for error processing or the like are omitted.

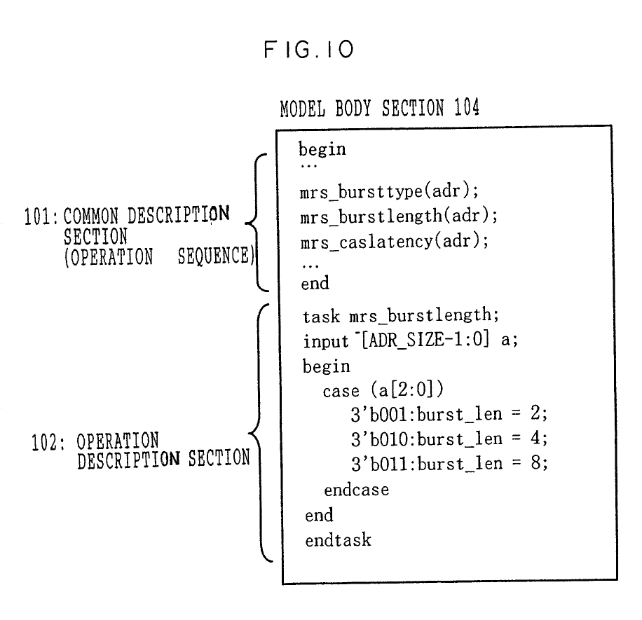

For example, when the operational description which supports three burst lengths of 2, 4 and 8 is to be incorporated (i.e., when the operation parameter “BL_TYPE_{—}1” is designated in the operation parameter file), the operational description of the operation parameter “BL_TYPE_{—}1” (file name: mrs_burstlength_bl_type_{—}1.v), which was indicated in FIG. 9A, is incorporated into the common descriptive section 101, as shown in FIG. 10.

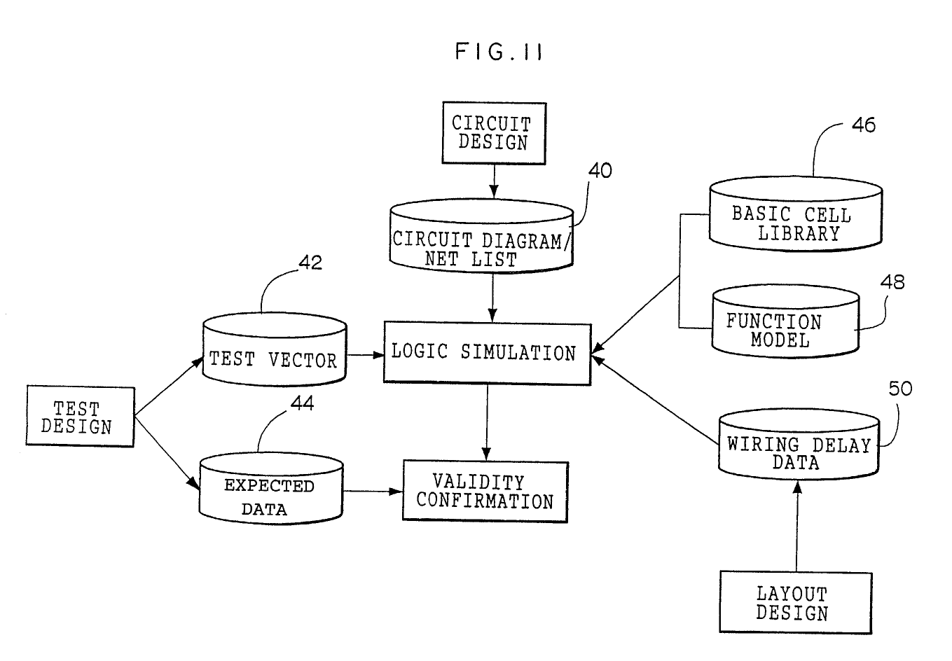

Referring now to FIG. 11, a procedure for the logic simulation using the logic simulation model generated by the logic simulation model generating apparatus 10 will be described. For example, a case in which a designer of the system verifies, through the logic simulation, operations of the system will be explained. For example, the system is a board having a plurality of the semiconductor devices mounted thereon or an LSI comprising a plurality of the semiconductor devices. In FIG. 11, an LSI having an SDRAM and other semiconductor devices (i.e., an inverter, a flip-flop and the like) connected to the SDRAM. A functional model in FIG. 11 corresponds to the logic simulation model to be applied to the SDRAM.

First, a circuit diagram/net list 40 of the LSI is prepared by designing the LSI circuit for which the logic simulation is to be executed. A test vector 42 and expected data 44 are generated by the test designing of the LSI. Further, a basic cell library 46 including data for basic cells such as an inverter, a flip-flop and the like, which will be necessary during the logic simulation of the LSI, is prepared. The test vector 42 is the test data that is inputted, via an input terminal of the LSI, into the LSI, which is to be logic simulated. The expected data 44 indicates output data in cases in which the LSI has no defects when the test vector 42 is entered.

Then, an entire logic simulation model is generated from a combination of the logic simulation model (the functional model 48) and the basic cell library 46 and the circuit diagram/net list 40. The logic simulation is implemented by inputting the test vector 42 into the logic simulation model.

If the logic simulation model as a whole has no defects, the output data obtained by the logic simulation corresponds to the expected data 44, whereby the validity of a circuit diagram/net list will be confirmed.

Note that, a more detailed verification can also be carried out in the logic simulation by adding wiring delay data 50 based on the layout design of the LSI to be logic simulated. Further, the logic simulation as described above can also be implemented by various devices in addition to the logic simulation model generating apparatus 10 relating to the present embodiment.

As explained in detail above, in the logic simulation model generating apparatus 10 and the method for generating a logic simulation model relating to the present embodiment, a logic simulation model is generated in the following manner: regarding the semiconductor device (the semiconductor memory in the present embodiment) for which the logic simulation model is to be generated, several types of operational descriptions having different functions are stored in advance in the hard disk for each predetermined command operation; among the several types of operational descriptions, the specifying information (the information included in the operational parameter file in the present embodiment) which specifies the operational description that will be applied to the logic simulation model is inputted into the hard disk; the operational description specified by the specifying information is read out of the hard disk; then a logic simulation model is generated based on the read operational description. Thus, the manpower required for generation and maintenance of the logic simulation model can be greatly decreased. The method for generating the logic simulation model relating to the present embodiment can be very effectively executed when applied to semiconductor devices such as the SDRAM or the like that may include various combinations of operations for common commands.

Further, in the apparatus 10 and the method for generating a logic simulation model relating to the present embodiment, a logic simulation model is generated for the semiconductor device in the following manner: the physical information, the timing information relating to the operational timing (the terminal definition and the timing definition in the present embodiment, respectively), and the description indicating the operational sequences that are common in each type of semiconductor device are stored in advance in the hard disk 20 as common information; the specifying information, and the numeric information of the physical and timing information (information included in the physical size file and the timing file, respectively) for the semiconductor device for which the logic simulation model will be generated are entered into the hard disk; the operational description specified by the specifying information and the common information corresponding to the type of the semiconductor device for which the logic simulation model is to be generated are read out of the hard disk; then the logic simulation model is generated in accordance with the read operational description, the common information and the numeric information. Thus, the method for generating a logic simulation model can be applied to various derivative products having different physical conditions or operational timing conditions.

Further, according to the apparatus 10 and the method for generating the logic simulation model relating to the present embodiment, since the semiconductor device is a semiconductor memory, a logic simulation model in accordance with various physical conditions or operational timing conditions can be generated or maintained with fewer procedures.

Further, according to the logic simulation model generating apparatus 10 and the method for generating the logic simulation model relating to the present embodiment, the operational unit is a command unit. Accordingly, a logic simulation model can be generated by selectively applying one of several types of operational descriptions having different functions to each command of the semiconductor memory. As a result, the structure of the logic simulation model can be simplified.

Furthermore, according to the logic simulation model generating apparatus 10 and the method for generating the logic simulation model relating to the present embodiment, the group of operational description libraries and the common descriptive section whose contents and operations have been sufficiently verified are used. Accordingly, a logic simulation model whose operations have been fully verified can be generated.

Although the logic simulation model of the present embodiment was explained in conjunction with the SDRAM as a semiconductor memory for which the logic simulation model will be generated, the present invention is not limited to the same. The present invention can be applied to any semiconductor memories including the DRAM, the ROM, the flash memory, and the like, and achieve the same effects as those achieved by the present embodiment.

Further, although the generation of the logic simulation model of the present invention was explained in conjunction with the semiconductor memory, any semiconductor devices including a counter, a register, a multiplexer and the like may also be used as the semiconductor device of the present invention.

Further, although the description of the logic simulation model of the present embodiment was explained in conjunction with Verilog-HDL, other hardware description languages including VHDL may also be used and achieve the same effects as those achieved by the present embodiment.

Although in the present embodiment, parameters are inputted by reading out the text files of the physical size parameters, the timing parameters and the operational parameters that are stored in advance, the present invention is not limited to the same. The operator of the apparatus 10 may enter such parameters directly using the keyboard 14, the mouse 16, and the like and achieve the same effects as those achieved by the present embodiment.

What is claimed is:

1. A method for generating a logic simulation model of a semiconductor device, comprising:
storing in advance, in a storing section, several types of operational descriptions having different functions for each predetermined operational unit of a semiconductor device for which the logic simulation model is to be generated;
inputting specifying information, which specifies the operational descriptions, among the several types of operational descriptions, to be applied to the logic simulation model to the storing section;
reading out the operational descriptions specified by the specifying information from the storing section; and
generating the logic simulation model based on the read operational descriptions.

2. A method according to claim 1, further comprising:
storing in advance, in the storing section, physical information and timing information for operational timing, which are common for each type of semiconductor device, and sequential information indicating operational sequence as common information for the semiconductor device for which the logic simulation model is to be generated;
inputting, into the storing section, specific numeric information defining the physical information and the timing information for the semiconductor device;
reading out the operational descriptions specified by the specifying information, and the common information corresponding to the type of the semiconductor device from the storing section; and
generating the logic simulation model based on the read operational descriptions and the common information that are read out and the numeric information.

3. A method according to claim 1, wherein the semiconductor device is a semiconductor memory.

4. A method according to claim 1, wherein the operational unit is a command unit.

5. A method according to claim 1, wherein the storing section is a hard disk.

6. A method for generating a logic simulation model of a semiconductor device using a storing section, the method comprising:
storing a plurality of command operational information specifying each of several types of command operations that are executed by the semiconductor device, and several types of operational descriptions having different functions, which are included in each of the several types of command operations, in the storing section;
inputting specifying information into the storing section that specifies the operational descriptions, from among the several types of operational descriptions, to be applied to the logic simulation model; and
generating the logic simulation model by reading out, from the storing section, the operational descriptions specified by the specifying information and generating the logic simulation model based on the read operational descriptions read.

7. A method according to claim 6, wherein:
the storing step further storing, in the storing section, physical information, timing information controlling operational timing, and sequence information indicating operational sequence, which are common for each type of semiconductor device as common information;
the inputting step further inputting numeric information defining the physical information and the timing information applied to the logic simulation model, and inputting specifying information corresponding to the type of the semiconductor device specified by the sequential information as the specifying information; and
the generating step generating the logic simulation model by reading out, from the storing section, the operational descriptions specified by the specifying information and the common information that corresponds to the type of the semiconductor device for which the logic simulation model is to be generated, and generating the logic simulation model based on the operational descriptions and the common information, which were read, and the numeric information.

8. A method according to claim 6, wherein the semiconductor device is a synchronous dynamic random access memory.

9. A method according to claim 6, wherein:
the operational descriptions to be described in the operation descriptive section are stored as libraries for each type of corresponding command operation; and
the generating step selectively incorporates one of the operational descriptions for each of the command operations into the logic simulation model to be generated.

10. A method according to claim 6, wherein the storing section is a hard disk.

11. A method for simulating a system including a semiconductor device, comprising of:
storing, in a storing section, command operation information for specifying each of several types of command operations that are executed by the semiconductor device and for specifying several types of operation descriptions having different functions that are included in each of the several types of command operations;
inputting specifying information into the storing section that specifies the operation descriptions, from among the several types of operation descriptions, to be applied to the semiconductor device;
reading out, from the storing section, the operation descriptions specified by the specifying information;
generating a function model based on the read operation descriptions;
preparing a cell library comprising the system with the semiconductor device;
preparing a circuit diagram or a net list of the system;
generating test data that is inputted into the system and expected data that is outputted from the system when the test data is entered in the no defective system;
generating a logic simulation model to be applied to the system, which is a combination of the function model and the cell library, the combination based on the circuit diagram or the net list; and
confirming that the logic simulation model is valid by comparing the expected data to an output data from the logic simulation model in which the test data is entered.

12. A method according to claim 11, wherein the logic simulation model includes wiring delay data based on the semiconductor device.
